(19) United States
(12) Patent Application Publication
(10) Pub. No.: US 2014/0058754 A1
(43) Pub. Date: Feb. 27, 2014

(54) PROFESSIONAL NETWORKING PLATFORM WITH RANKED PATIENT INFORMATION DELIVERY

(71) Applicant: David WILD, Raleigh, NC (US)

(72) Inventor: David WILD, Raleigh, NC (US)

(21) Appl. No.: 13/973,554

(22) Filed: Aug. 22, 2013

Related U.S. Application Data
(60) Provisional application No. 61/691,992, filed on Aug. 22, 2012.

(51) Int. Cl. G06F 19/00; G06Q 50/00

(52) U.S. Cl. CPC G06F 19/3425; G06Q 50/01
USPC 705/3

(57) ABSTRACT

Provided are a method, system, means for, and processor-readable non-transitory medium incorporating instructions that provide a social network platform, particularly for members in a professional field. Patient data is received from an electronic patient data source. Target patient information associated with a first patient is identified, when the first target patient information corresponds to the at least one evaluation criterion, and the first patient is assigned a first priority ranking, according to the at least one evaluation criterion. According to the assigned first priority ranking, information regarding the first patient is displayed to the members of the social network more prominently than information regarding other patients of the plurality of patients. Weighting of the target information according to the evaluation criterion may be performed. The first priority ranking may correspond to acuity of a health condition of the first patient.

### CROSS REFERENCE TO RELATED APPLICATION

The present application claims priority to U.S. Provisional Patent Application No. 61/691,992, filed Aug. 22, 2012, the entire contents of, all of which are incorporated by reference herein.

### BACKGROUND

1. Field of the Disclosure

The present disclosure relates to a social networking-type platform for physicians and other caregiver professionals and to a delivery method and system that ranks patient information to be delivered.

2. Related Art

Social networking platforms provide worldwide web-based tools for bringing people closer and facilitating communication. Professional networking platforms exist geared toward industries and professionals. Caregivers, including physicians, are bombarded with an enormous amount of information. Thus, while social networking platforms and professional networking platforms, including Facebook, Yammer, LinkedIn, MySpace, Twitter, and the like exist, and enterprise-specific networking, and some social networking sites, such as Facebook, provide a News Feed feature, care must be taken to insulate members of the network from irrelevant or non-useful information and to protect members from being inundated with trivial information or information that is of possible relevance but not as directly relevant as other information.

The need to communicate with fellow physicians and other caregivers is important for effective collaboration, effective diagnosis and treatment of patients, and for collaboration on research. However, each caregiver or physician is responsible for, comes into contact with or sees many patients on a weekly basis, and collaborates with other caregivers on those other caregivers' patients regarding yet more patients. The need to communicate is vital for the success of patient care, professional learning and growth, and efficiency in hospital or other organization operations. Often, healthcare providers, including physicians, lack a convenient collaborative method to view and share patient information in a secure way and in a way that does not overwhelm the caregiver with non-relevant or marginally relevant patient and medical information. Physician communication and physician access to patient information can be cumbersome. Handheld devices, including mobile telephones, smartphones, and other types of networked devices often are ineffective in providing access to physicians on a real time basis and in a secure fashion.

Hospitals and other clinical organizations often have vast amounts of patient data and thus there is a pressing need for making relevant data available for professional caregivers who need it. At the same time, the healthcare industry is a large and growing sector of the economy and the business opportunity for providing effective access for physicians and other caregivers to patient data is enormous.

In 2009, with the signing into law of the American Recovery and Reinvestment Act of 2009, the U.S. government specifically directed almost $23 billion to healthcare information technology and certified EHR (Electronic Health Records) technology through the Health Information Technology for Economic and Clinical Health Act (HITECH), which was incorporated into the Recovery Act. As part of HITECH, the U.S. government released $2 billion for the Office of the National Coordinator to “jump start” EHR adoption and to spur the development of a national health information infrastructure. However, the expanding use of computerized medical systems, which are designed around the patient-tracking process (via EHRs), has been increasing in complexity and fragmenting patient data into vast, sometimes disparate, information systems. These legacy platforms do not allow for any of the clinical collaboration and communication necessary for optimal patient care and the efficiency required in modern healthcare delivery.

HL-7/IHE is a patient information standard organization that provides standards to support clinical practice and management for delivery and evaluation of health services. Often, data is maintained in a relational database using the tables with a rows and columns approach that make effective real time access to relevant patient data very difficult for healthcare providers.

### SUMMARY

A system, device, a method, a computer or processor-readable medium product incorporating a program of instructions for controlling a computer to perform the method, and a means for carrying out a method of providing a social networking platform for professional caregivers are described. The networking platform facilitates the exchange of information among caregivers, allows caregivers to consult with other members of a group of users of the networking platform regarding a patient, and to update patient information made available to the other members of the group so as to facilitate diagnosis and treatment of patients collaboration and research.

The networking platform also enhances opportunities for professional experience and development by allowing members of a group of caregivers to see how other professional caregivers, such as physicians, evaluate, analyze and think about patient information. The networking platform also facilitates contact and communication between physicians or other caregivers regarding the patients or regarding other professional or non-professional matters.

A triage algorithm which evaluates patient information and ranks it according to a list of criteria weighted by weighting factors, and then based on the ranking determines whether the piece of patient information is made available to other members of the group of users is also described.

Provided is a processor-readable non-transitory medium incorporating instructions configured to provide, when executed by a data processor, a social network platform, such as a server that provides a virtual social network, that is accessible, over a computer network, by members of a social network, the instructions comprising:

an evaluation criterion storage module configured to store and to retrieve at least one evaluation criterion;
a patient data reception module comprising instructions configured to receive, from an electronic patient data source, patient data regarding a plurality of patients;
an information ranking engine comprising instructions configured to identify, in the patient data, first target patient information associated with a first patient, when the first target patient information corresponds to the at least one evaluation criterion, and to assign a first priority ranking, according to the at least one evaluation criterion, to the first patient of the plurality of patients;
a network member updater comprising instructions configured to provide, according to the assigned first priority ranking, information regarding the plurality of patients such that information regarding the first patient is displayed to the members of the social network more prominently than information regarding other patients of the plurality of patients.

For the processor-readable non-transitory medium, the patient data source may be a data feed from an electronic medical records system.

The information regarding the first patient may be displayed at a position higher on a display of the members of the social network than information regarding the other patients of the plurality of patients. The information regarding the first patient may be displayed using at least one of a font, a character style, an underlining, a bolding, and a color different from that of the other patients of the plurality of patients.

The evaluation criterion may include at least two criteria, and the first priority ranking may correspond to an acuity of a health condition of the first patient.

The information regarding the first patient may be displayed such that a findings field of the patient data is displayed more prominently than any other medical patient data for the first patient. Such a findings field may include conclusions, findings, impressions or recommendations of a health care professional based on an analysis by the health care professional of a medical information regarding the first patient.

The information ranking engine may identify in the patient data second target patient information corresponding to the at least one evaluation criterion; and assign a second priority ranking, according to the at least one evaluation criterion, to a second patient of the plurality of patients, when the target patient information is associated with the second patient, wherein the network member updater provides information to the members of the social network such that, when the first priority ranking is higher than the second priority ranking, the information regarding the first patient is displayed more prominently than information regarding the second patient, and, when the second priority ranking is higher than the first priority ranking, the information regarding the second patient is displayed more prominently than the information regarding the first patient, and, such that the information regarding the first and second patients is displayed more prominently than information regarding the other patients of the plurality of patients.

The processor-readable non-transitory medium may further comprise:

filter instructions comprising instructions configured to receive from a first member of the social network a filter selection designating a new content filter to be applied to the patient data regarding the plurality of patients, and to identify, as a subset of patients of the plurality of patients, patients who have information received within a previously specified period of time by the patient data reception module,
wherein the network member updater provides information to the members only for the subset of patients.

The processor-readable non-transitory medium may further comprise:

filter instructions comprising instructions configured to receive from a first member of the social network a filter selection designating a status filter to be applied to the patient data regarding the plurality of patients, and to identify, as a subset of patients of the plurality of patients, patients who have patient information indicating a change in medical status received by the patient data reception module,
wherein the network member updater provides patient information to the members only for the subset of patients.

The processor-readable non-transitory medium may further comprise:

filter instructions comprising instructions configured to receive from a first member of the social network a filter selection designating a laboratory filter to be applied to the patient data regarding the plurality of patients, and to identify, as a subset of patients of the plurality of patients, patients who have patient information indicating a laboratory report received by the patient data reception module,
wherein the network member updater provides patient information to the members only for the subset of patients.

The processor-readable non-transitory medium may further comprise:

filter instructions comprising instructions configured to receive from a first member of the social network a filter selection designating an imaging filter to be applied to the patient data regarding the plurality of patients, and to identify, as a subset of patients of the plurality of patients, patients who have patient information indicating a report describing medical imaging received by the patient data reception module,
wherein the network member updater provides patient information to the members only for the subset of patients.

The processor-readable non-transitory medium may further comprise:

filter instructions comprising instructions configured to receive from a first member of the social network a filter selection designating a past patient filter to be applied to the patient data regarding the plurality of patients, and to identify, as a subset of patients of the plurality of patients, patients for whom the first member had previously provided care and to whom the first member is not currently assigned,

wherein the network member updater provides information to the members only for the subset of patients.

The processor-readable non-transitory medium may further comprise:

social network database instructions, wherein the members are represented as nodes, and the database uses a graph data model architecture for relating nodes to each other.

The information ranking engine may be configured identify, in the first patient target information, a first numeric value associated with the at least one evaluation criterion, and to assign the priority ranking by first assigning a first weight to the first numeric value.

The at least one information criterion may also include a first evaluation criterion and a second evaluation criterion different from the first evaluation criterion, and

the information ranking engine may identify, in a second patient target information associated with the first patient, a second numeric value associated with the second evaluation criterion,
assign a second weight to the second numeric value, and
assign the priority ranking according to a sum of the first numeric value multiplied by the first weight and a second numeric value multiplied by the second weight.

The at least one evaluation criterion may include at least one of a time since admission, a patient age, a number of prescribed medications, a number of exams within a previously specified previous period, a number of diagnosed medical conditions, and a number of care giver queries of patient status within a previously specified previous period.

The processor-readable non-transitory medium may further include:

a professional field storage module configured to store and to retrieve a professional field of members,
wherein the information updater provides the patient information regarding the plurality of patients only to a subset of the members of the social network whose professional field is relevant to the medical status of the patient.

The processor-readable non-transitory medium may further include:

a professional field storage module configured to store and to retrieve a professional field associated with each member, each professional field associated with a plurality of medical condition fields, each medical condition field comprising a medical field relevance value,

wherein the information ranking engine further comprises instructions configured to identify medical condition data for the first patient, and to assign, according to the medical field relevance value, a professional field ranking to each member for the first patient of the plurality of patients, and

wherein the network member updater further comprises instructions configured to provide, according to the professional field ranking, information regarding the first patient more prominently than information regarding other patients of the plurality of patients for members with a high professional field ranking.

The patient data source may be a data feed from a records system compliant with HL 7.

Also provided is a method of providing a social network platform by a data processor, the platform being accessible, over a computer network, by members of a social network, the method comprising:

storing a first evaluation criterion and a second evaluation criterion different from the first evaluation criterion;
receiving automatically, from an electronic medical records system, patient data regarding a plurality of patients;
identifying automatically, in the patient data, by the data processor, first target patient information associated with a first patient and corresponding to the first evaluation criterion, including a first numeric value associated with the first evaluation criterion, and assigning a first weight to the first numeric value, for a first patient of the plurality of patients;
identifying automatically, in the patient data, second target patient information associated with a second patient and corresponding to the second evaluation criterion, including a second numeric value associated with the second evaluation criterion, and assigning a second weight to the second numeric value, for the first patient;
assigning automatically, by the data processor, a first priority ranking according to a sum of the first numeric value multiplied by the first weight and a second numeric value multiplied by the second weight; and
transmitting automatically, by the data processor, according to the assigned first priority ranking, information regarding the plurality of patients such that information regarding the first patient is displayed to the members of the social network more prominently than information regarding other patients of the plurality of patients.

In such a method, the first and second evaluation criteria may each comprise at least one of a time since admission, a patient age, a number of prescribed medications, a number of exams within a previously specified previous period, a number of diagnosed medical conditions, and a number of care giver queries of patient status within a previously specified previous period.

The method may further comprise:

selecting automatically, as followers of the first patient, a subset of the members comprising fewer than all members,
wherein the followers comprise care givers who have at least one of ordered a test for the first patient, ordered a laboratory analysis for the first patient, ordered medical imaging for the first patient, and prescribed a medication for the first patient,
wherein the transmitting of the patient information for the first patient is performed only to the followers of the first patient.

This method may further comprise:

receiving a follow patient instruction from a first member; and

automatically adding the first member, as a follower of the first patient, responsive to the follow patient instruction received.

Further described is a method of providing, by a data processor, a platform for ranking each location of a plurality of locations, a current patient being associated with each location, the platform being accessible, over a computer network, by members, the method comprising:

receiving for each location, from an electronic data source, data regarding a status of the patient associated with the respective location, the patient status information indicating steps necessary before patient discharge;
ranking each location, based on the patient status information, according to a number of the steps, such when the patient status information shows fewer steps, the respective location received a higher ranking; and
transmitting the data for each location in an order according to the ranking, such that a location with a higher ranking is displayed more prominently than other locations.

In such a method, each location may be a bed in a medical facility.

Other features and advantages of the present invention will become apparent from the following description of the invention that refers to the accompanying drawings.

### BRIEF DESCRIPTION OF THE DRAWINGS

FIG. 1 illustrates the networking platform manager and the information ranking engine modules, according to an aspect of the present disclosure.

FIG. 2 illustrates an example of a graph database architecture.

FIG. 3 illustrates a page of a professional networking platform for a user, according to an aspect of the present invention.

FIG. 4 is a flow chart showing an example of the patient information ranking algorithm according to an aspect of the disclosure.

FIGS. 5A-5H show example screens of a smartphone interface.

FIG. 6 illustrates patient data including lab results for a patient, according to an aspect of Applicant's invention.

FIG. 7A illustrates patient data provided to a member that is unfiltered, according to an aspect of Applicant's invention.

FIGS. 7B and 7C illustrate the patient data filtered, respectively, according to radiology patient information, and according to laboratory patient information, according to an aspect of Applicant's invention.

FIG. 8 illustrates a display to a member, a patient feed according to patient ranking, according to an aspect of Applicant's invention.

FIG. 9 illustrates a system for providing patient information from a hospital information system or electronic medical record system to the social network server, and to the end user who is a member of the social network, according to an aspect of Applicant's invention.

### DETAILED DESCRIPTION OF THE EMBODIMENTS

According to an aspect of the present disclosure, network platform controller 10 and information ranking engine 20 can work together to streamline patient information delivered to physicians or other caregivers who are members of the professional networking system so as to deliver only relevant and timely information. According to an aspect of the present disclosure, a number of factors about the patient or about the piece of information for a patient are weighted so as to produce a triage ranking of each piece of patient information. Based on the triage ranking, the piece of patient information can then be fed to physicians or other healthcare providers for whom a relevance is determined.

Healthcare providers or caregivers, as these terms are used herein, can mean physicians, surgeons, dentists, chiropractors, physician's assistants, medical organization administrators, physical or occupation therapists, nurses and other allied health professionals, alternative healthcare providers and practitioners, nutritionists, diagnosticians, pharmacists or the like.

Physicians, as used herein, include MBs, DMs, doctors of osteopathic medicine and physician otherwise credentialed, including physicians credentialed abroad. In addition to registered nurses, licensed practical nurses and TCs (technicians) may also be sometimes referred to herein as caregivers or members.

A piece of patient information can include any type of information provided according to, for example, an HL-7 or IHE-supported protocol or other type of EHR (Electronic Health Record).

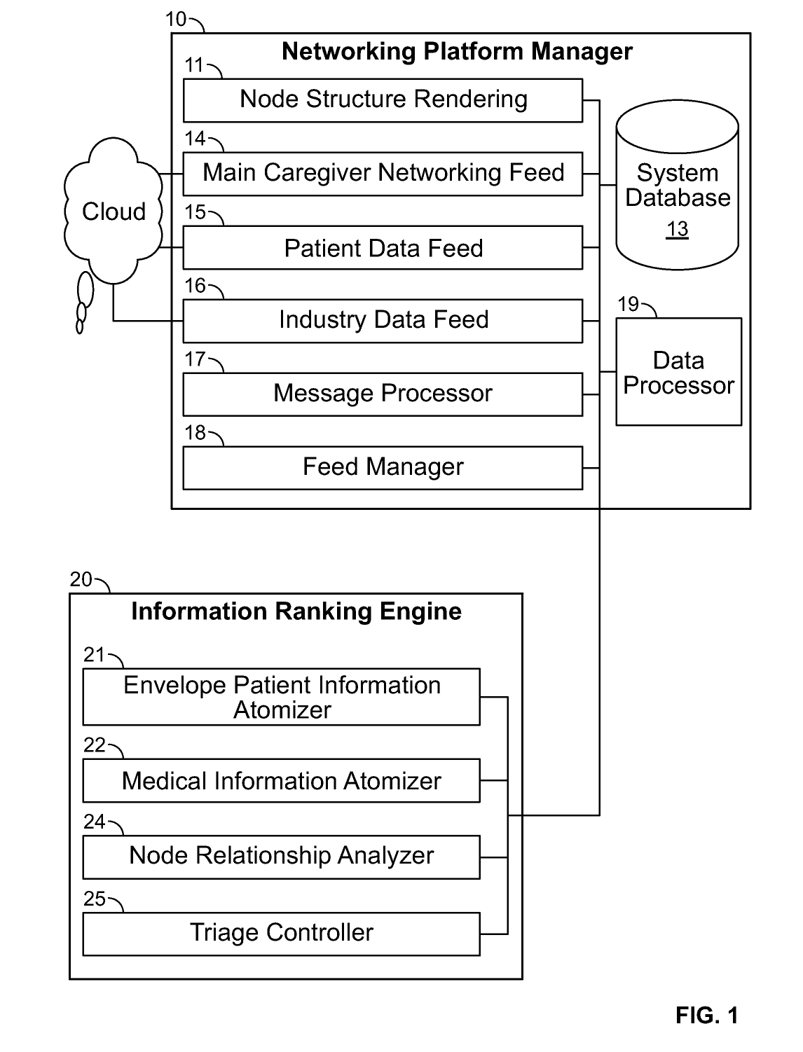

FIG. 1 illustrates a networking platform manager 10 and an information ranking engine 20 according to an aspect of the disclosure.

Node structure rendering 11 provides the overall display to the user of the system. Users may be limited to physicians or other caregivers of an organization, such as a hospital, clinic, medical center, physicians' practice group, dental office, outpatient facility, mental health organization or other healthcare providing organization or enterprise, or the like. Further, members of the network may be restricted to a particular group, unit, department, practice, ward, wing, agency, or a sub-group or combination of the foregoing within the hospital or organization, such as obstetricians and gynecologists and nurses of a hospital, or, to continue with this example, may also include pediatricians, anesthesiologists who work with this practice group, physician's assistants, professional level administrators, midwives, doulas, or the like. It will be understood that other allied healthcare professionals may also be included or restricted out from the professional group of the organization, depending on the setting and the users' preferences.

Like other social networking sites, members may “friend” each other, that is, members may join each other's network of collaborators. Alternatively, members can automatically be joined if they work in the organization or within the type of professional group within the organization discussed above. Alternatively, an ad hoc group of healthcare providers may form a network, dictated by a long-standing professional, organizational or personal affiliation, and such an ad hoc may be within an organization or may straddle caregivers within an organization and caregivers outside of the organization or organizational unit.

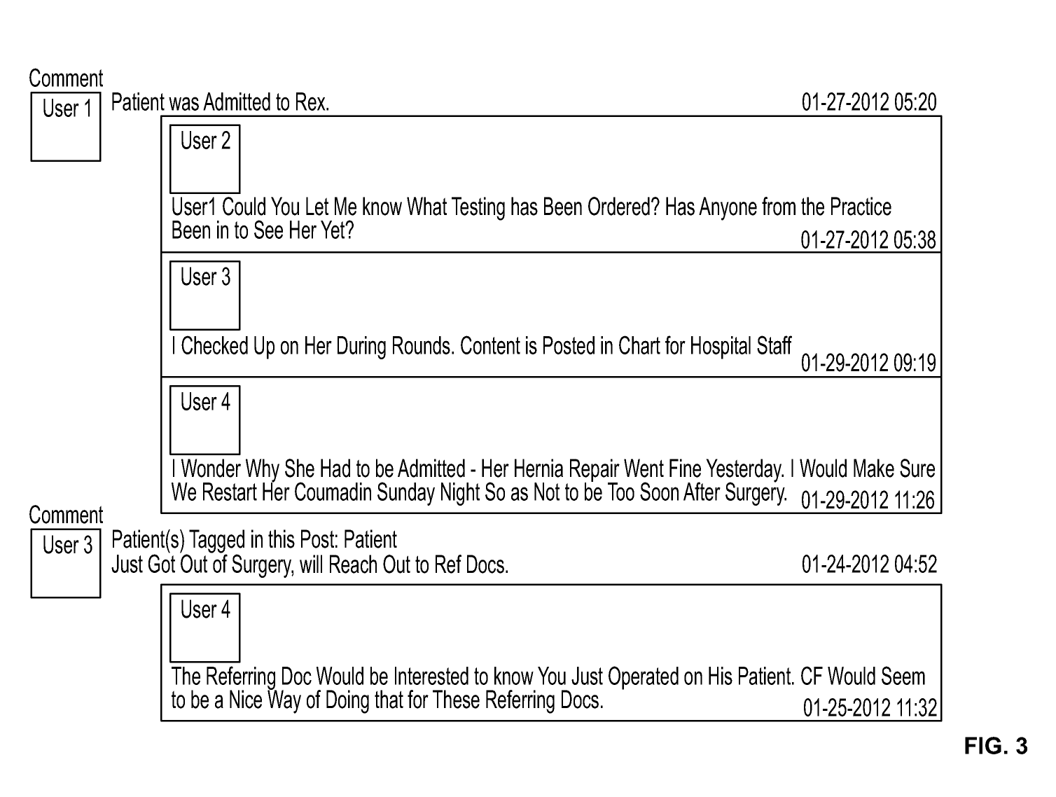

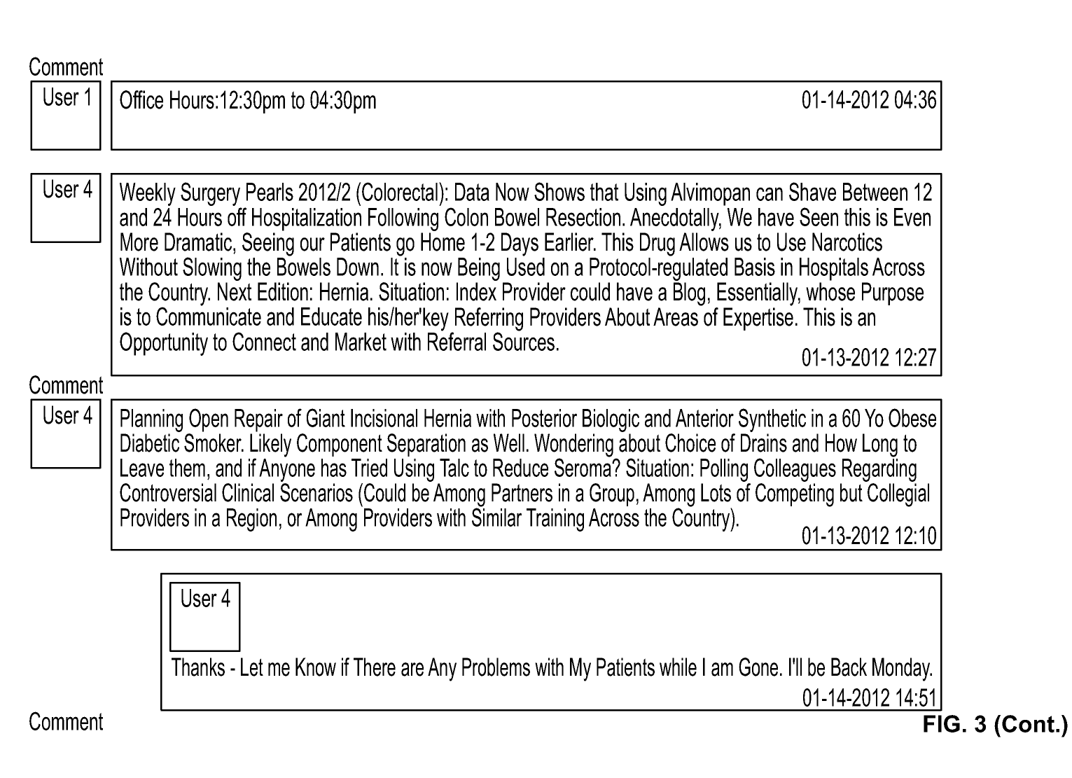

Node structure rendering 11 manages the output provided to members of the network. For example, as illustrated in FIG. 3, a member viewing his or her page sees caregivers with whom he or she is connected and sees comments provided by other members in response to status updates, news feeds, comments, patient information, or the like, generated for a member. Users may be asked to log-in using a password or otherwise to verify their membership in the group or in the organization before being granted access to the networking platform FIG. 3 illustrates a page viewed by a member, according to an illustrative example.

Main caregiver networking feed 14 receives input provided by members, for example, when they post a status update, add a patient, add personal information, post a comment, change their current or permanent location, change or update their affiliation with a hospital or an organization or with the group or unit of the hospital, add a “friend” or professional contact, add a professional organization, an educational or professional achievement, a title, change their name, or the like.

Patient data feed 15 receives patient data from a hospital, clinic, medical center, or other type of medical, healthcare giving, or other such organization or enterprise. For example, such patient data may be in the form of HL-7-compatible protocol or of the type of healthcare information system or EHR (Electronic Health Record) patient information. Patient data feed 15 may be received from a hospital, clinic or other medical or healthcare providing organization with which the members of the network are affiliated, or may be received from a third party supplier, from the patient, or from other healthcare providers either within the organization or outside the organization. Such third party providers may include diagnostic laboratories, medical imaging centers, radiology reports, pharmacies, physical or occupational therapists, mental healthcare providers, including psychologists, social workers, psychiatrists, counselors, pastoral counselors, or the like.

Information ranking engine 20 then evaluates the patient data received and transmits, on a selective basis, pieces of information received as patient data, or makes available upon request to members these pieces of information for the patient data.

Information ranking engine 20 includes medical information atomizer 22, which identifies and isolates pieces of information received by networking platform manager 10 via the patient data feed 15. Medical information atomizer 22 may identify, isolate, collate, interpolate, or otherwise process information about a patient connected to diagnosis, medication, testing, laboratory results, vital signs, associated with or describing the patient. Patient information may include test results, analysis, or laboratory-provided information, X-rays, CTs, CAT scans, MRIs, ultrasounds, or other types of medical imaging information, including analysis, images or summaries of the foregoing, clinical patient charts or hospital charts, physicians, nurses or other caregivers' notes or visitation records, doctors' or other caregivers' recommendations or referrals for diagnostic testing or medical imaging, vital signs records, such as EKG information, heart rate, pulse, blood count and blood testing information, including requests for blood history.

In addition, envelope patient information atomizer 21 identifies, isolates, collates, interpolates, or otherwise processes other information about the patient, including the time lapsed since admission, the time lapsed since a test was taken, the time lapsed since the most recent visit by a physician or a physician within the group or a physician within the medical organization, whether or not the patient admission is a readmission less than 30 days after the prior admission, or less than some other specified period of time after the prior admission, the number of exams the patient has had in the last 12 or 24 or 48 or 72 hours or within the last week or the last two weeks or the last month or the last 90 days or some other specified period of time, whether or not the particular member has a relationship with the patient, the number of medications the patient has been taking or has been prescribed, the patient's age, general health ranking, how often members have looked up the patient within the last 6 hours or 12 hours or 24 hours or 48 hours or 72 hours or a week or other specified period of time, that is, how many times members have viewed patient information connected with this patient, how many documented medical conditions or problems this patient has, and the service to which the patient was admitted or the original problem or medical area that brought the patient to one or more of the members of the system. Other types of such patient envelope information may include the location of the patient, whether the patient is currently admitted to the medical organization with which the members are affiliated or to any hospital or medical facility, the number of surgeries the patient has undergone in the last 5 years, 10 years, or throughout his or her lifetime, whether the patient has been diagnosed with any serious acute or chronic life-threatening conditions, such as cardiac disease, stroke, Alzheimer's, Parkinson's, cancer, AIDS, or the like, whether there is any known record of suicide attempt by the patient, whether any tests or lab results or medical imaging analysis is outstanding or remaining to be posted, whether the patient reports major pain, and so forth. Thus, envelope patient information may be defined as including information that is not generated by a physician, laboratory, medical imaging system, pharmacist, or the like, but is meta information about such medical information or is more general information about the patient and his or her history or relationship with healthcare professionals or healthcare providing organizations, or the like, dates of admission or discharge, more general information about the patient, such as age, weight, height, vital sign information, or other medical data, marital status, time since last admission, time since last surgery or procedure, reason for admission, symptoms about which the patient complained or noted, medications prescribed or taken by the patient or prescribed for future administration to the patient, identification of which physicians or other caregivers have a relationship with the patient, how many exams a patient has had in the last period of time, such as twenty-four, forty-eight, seventy-two hours, or a week or thirty days or the like, and so forth. Patient information may include actual current data about a patient, historical patient data about the patient, ideal parameters or statistical data about an ideal patient of the same type as the patient, diagnostic data about what the patient might be like, is expected to be like or ideally will be like in the future, and so on. Patient information can include ADT (Admission Discharge and Transfer) information, ORU (result) information, ORM (order) information, and CCD (Clinical Care Document) information, or the like and can include any of the weighting criteria.

Node relationship analyzer 24 identifies, isolates, collates, or otherwise processes information related to the status and relationship of the patient, and the primary member contact of the patient to the system with respect to the member of the system for whom the page is rendered, that is, the member of the system viewing his or her social networking platform. A patient may be classified as having a primary relationship with one member who is affiliated with the hospital, clinic, or medical organization, or one member of the group or practice within the hospital, clinic or medical organization as described above. This primary member may then have a collaborative relationship for all of his or her patients with all members of the organization or the group practice within the organization. Alternatively, the primary member to whom the patient belongs may only share patient information with other members who are members of a sub-group by virtue of the fact that the members of the sub-group who:

1. have contacted the primary member over the networking platform to establish a professional relationship with the primary member (contacting members);
2. have treated or visited this patient (overseeing members);
3. have been invited or requested by the primary member to view information about the patient and been given access (requested members);
4. have viewed previously patient information about this patient (transactional members);
5. have decided to follow a patient (following members). For example, members may decide to follow a patient based on interest in the symptoms of a patient or the frequent collaborative relationship with the primary member. In addition, members may decide to follow a patient based on facility location, facility site or unit, ordering physician, physician practice/group, physician specialty, patient status (for example, patient admitted or discharged), patient name, patient age or other such information about the patient, tests ordered for the patient, or test results received for the patient.

Members can choose to follow patients that are registered in a Healthcare Information System (HIS) or other type of EHR, or patients can automatically be linked and news or updates about the patient can be automatically pushed to the member automatically based on the criteria above-described.

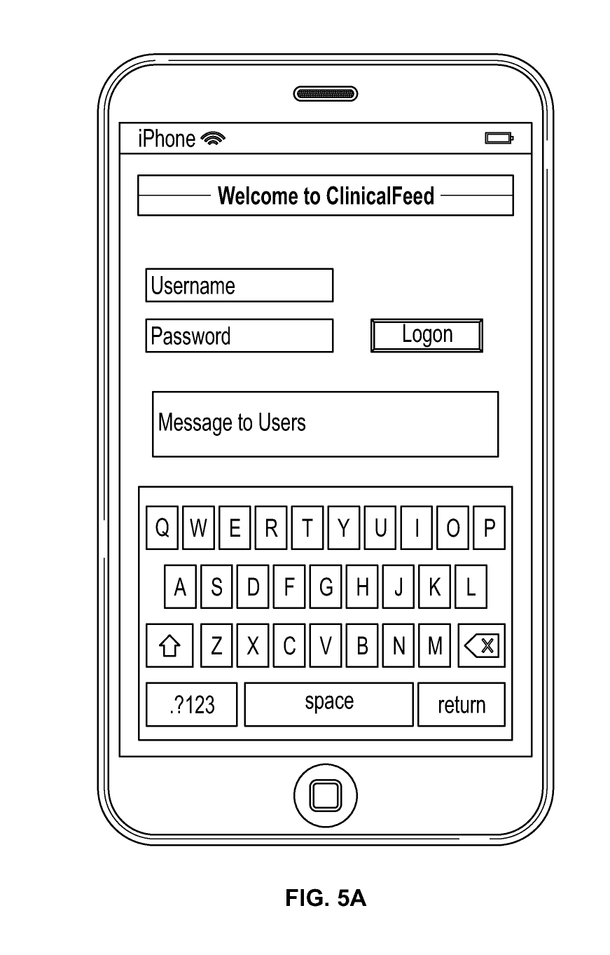

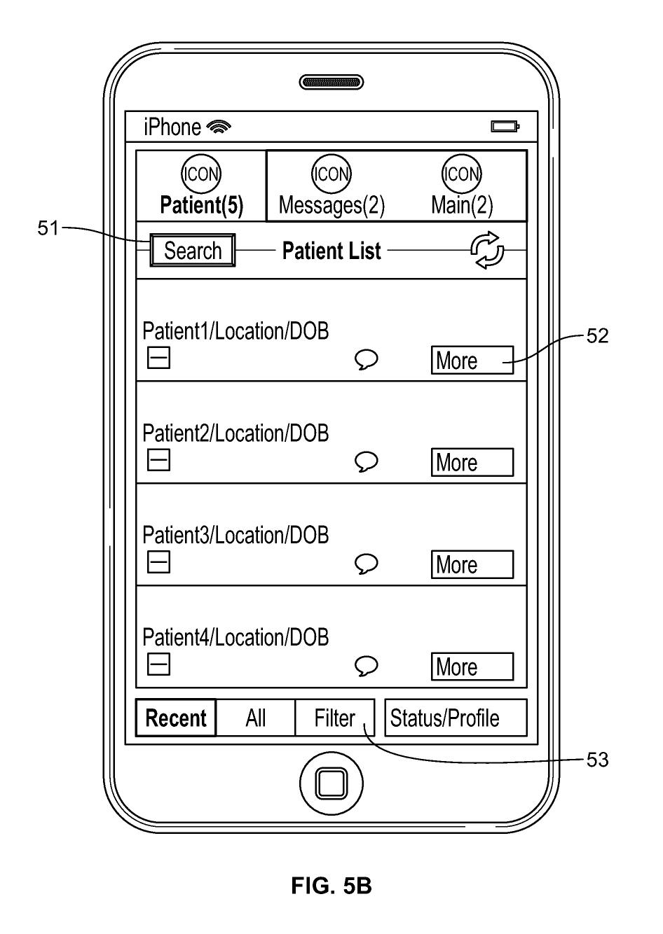

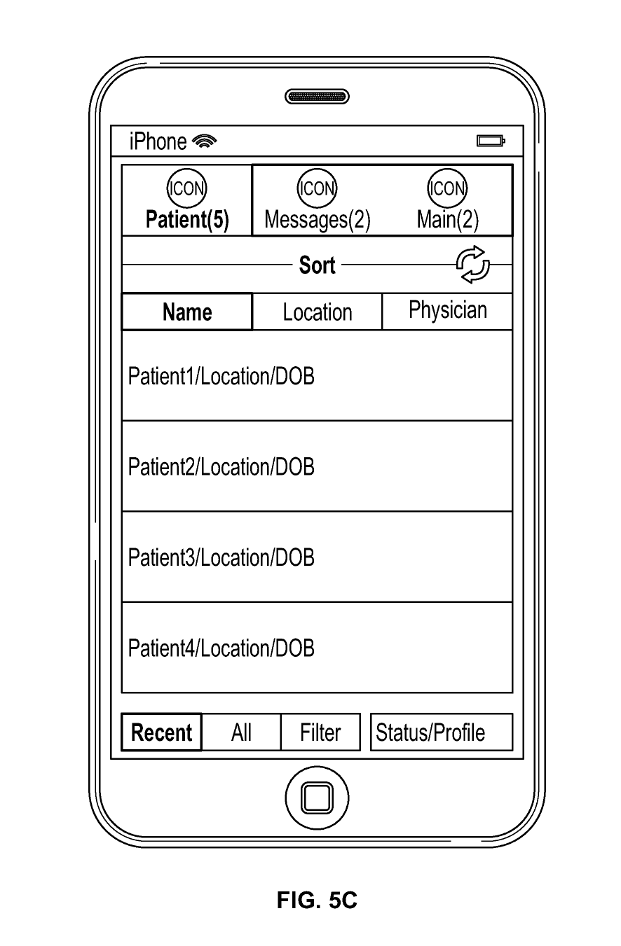

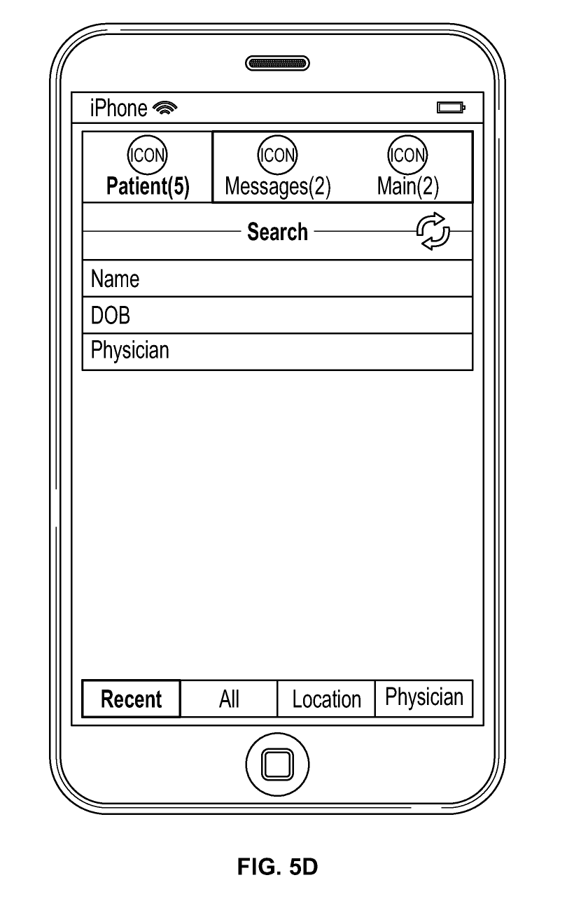

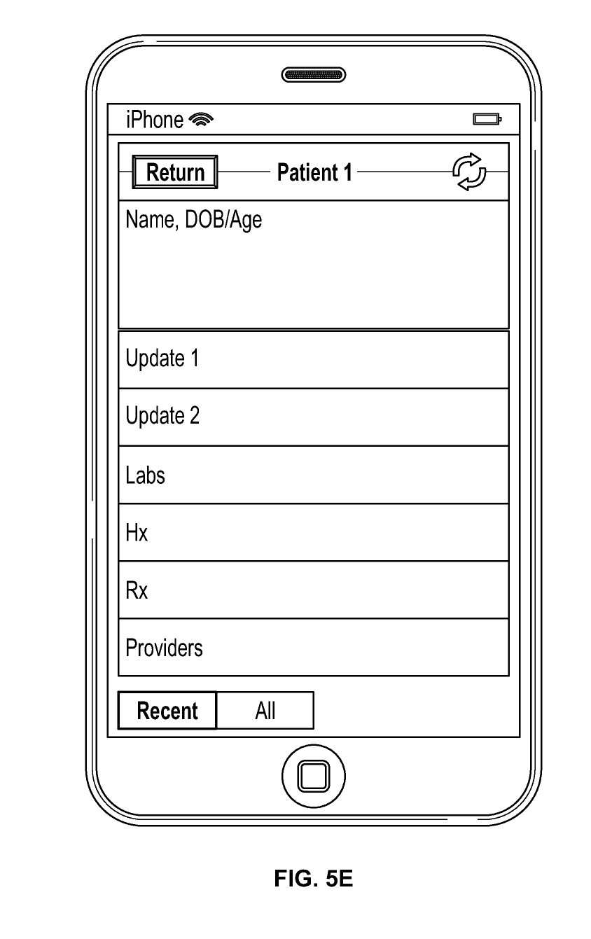

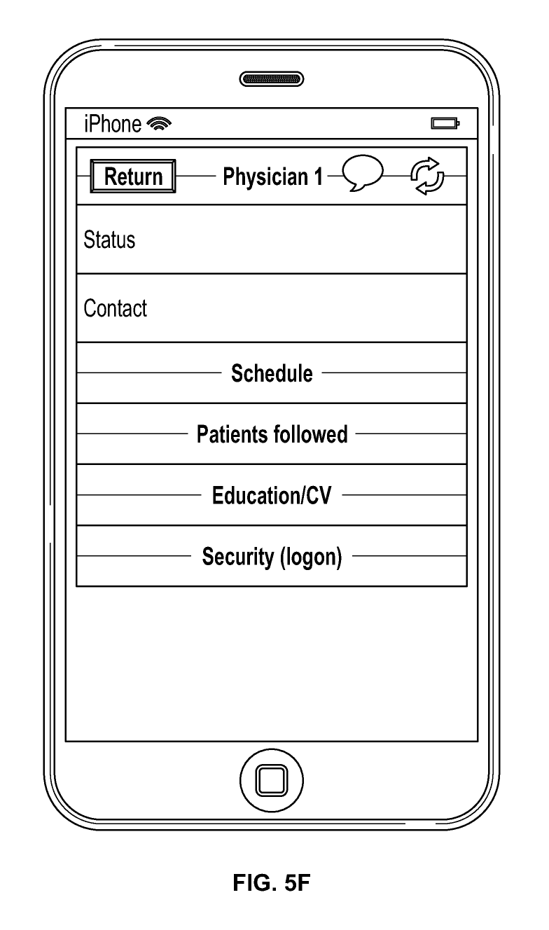

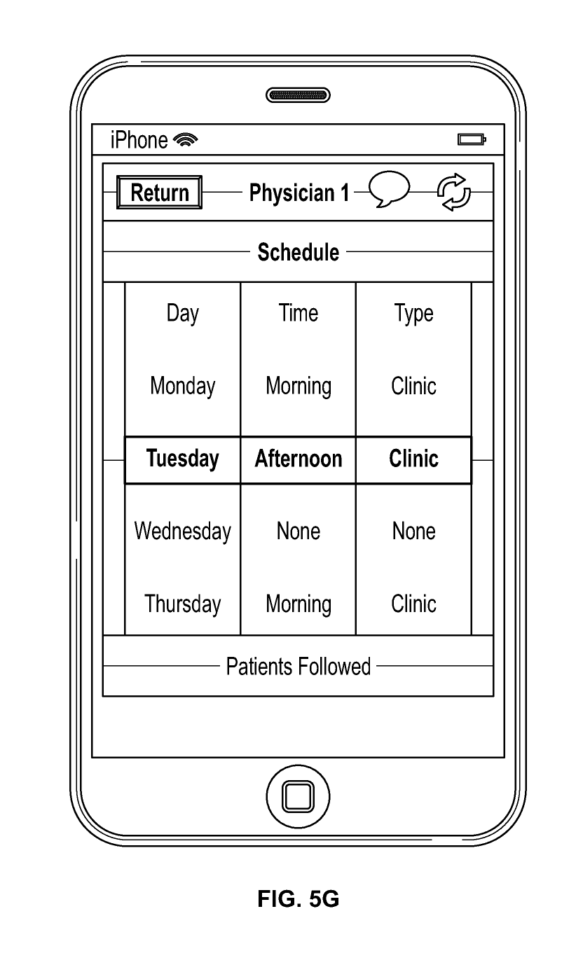

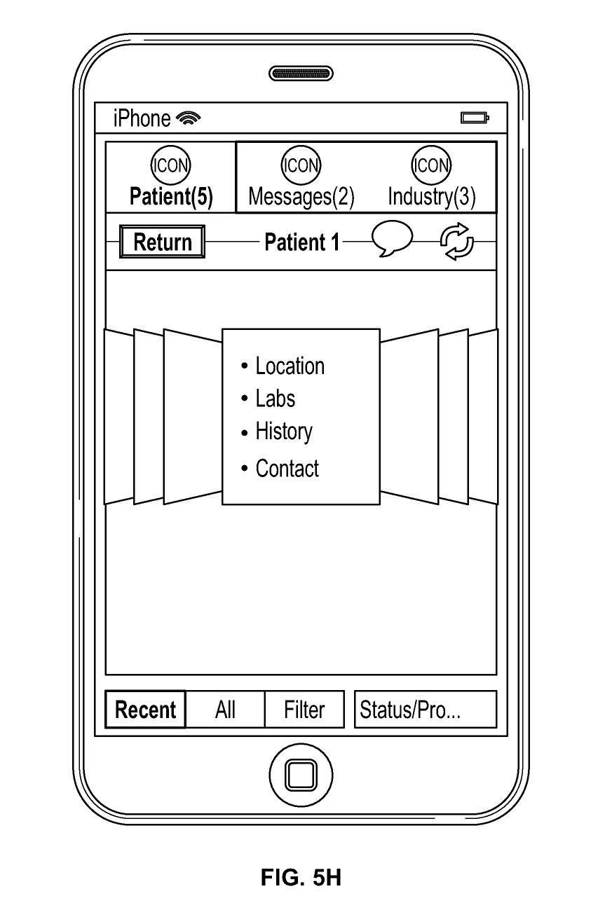

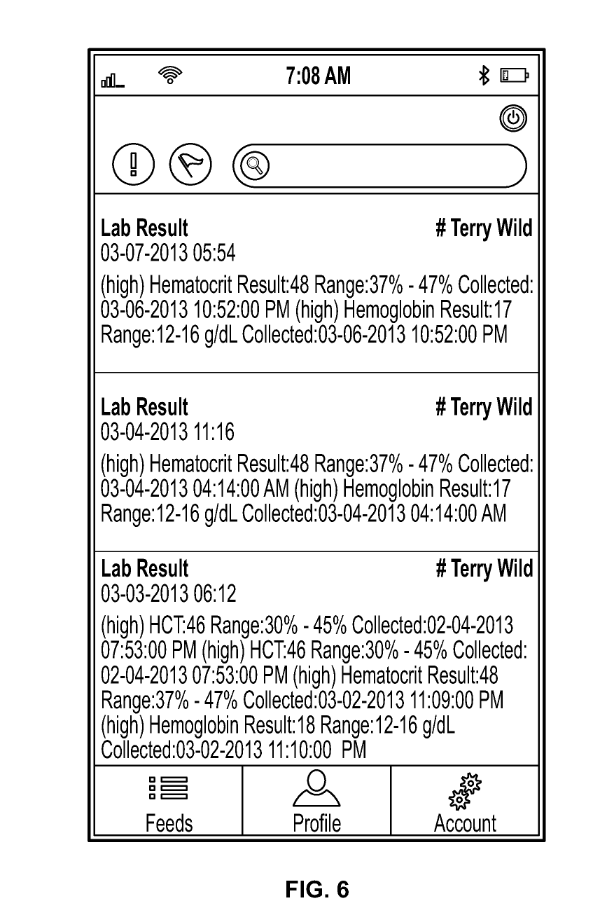

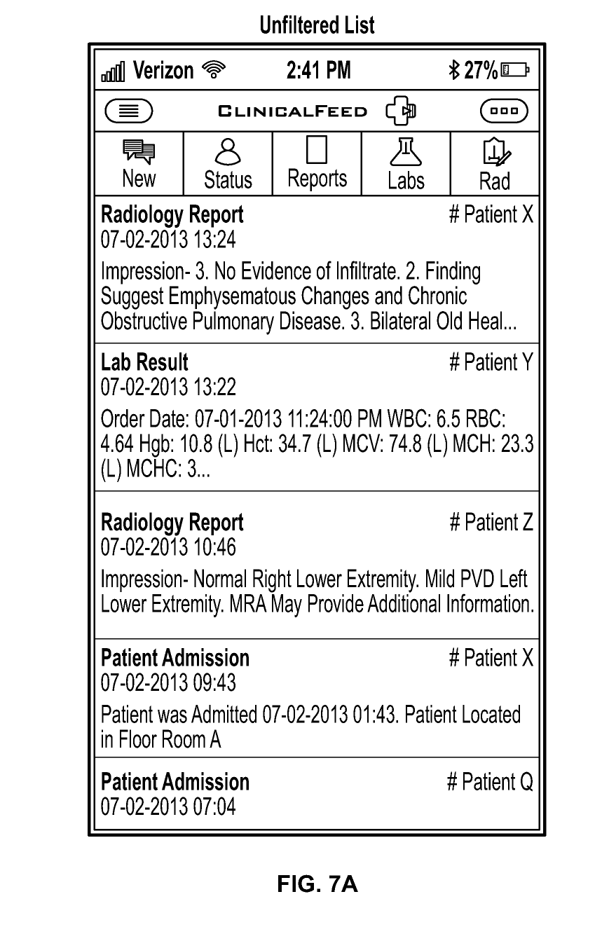

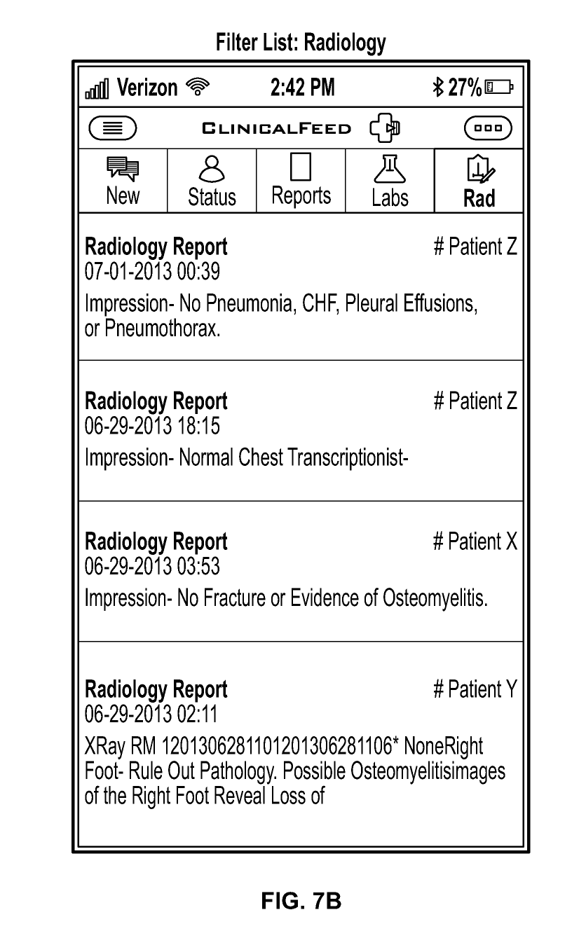

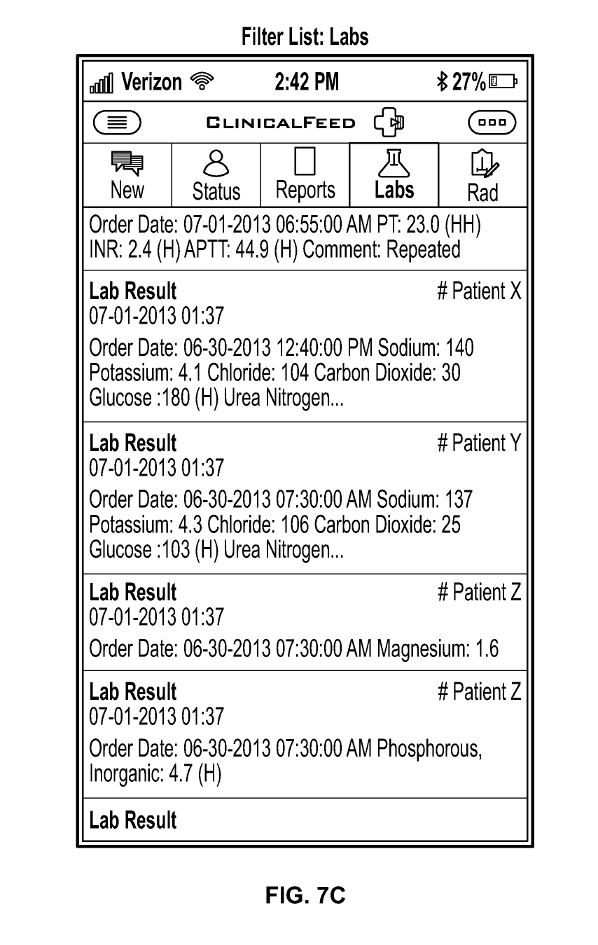

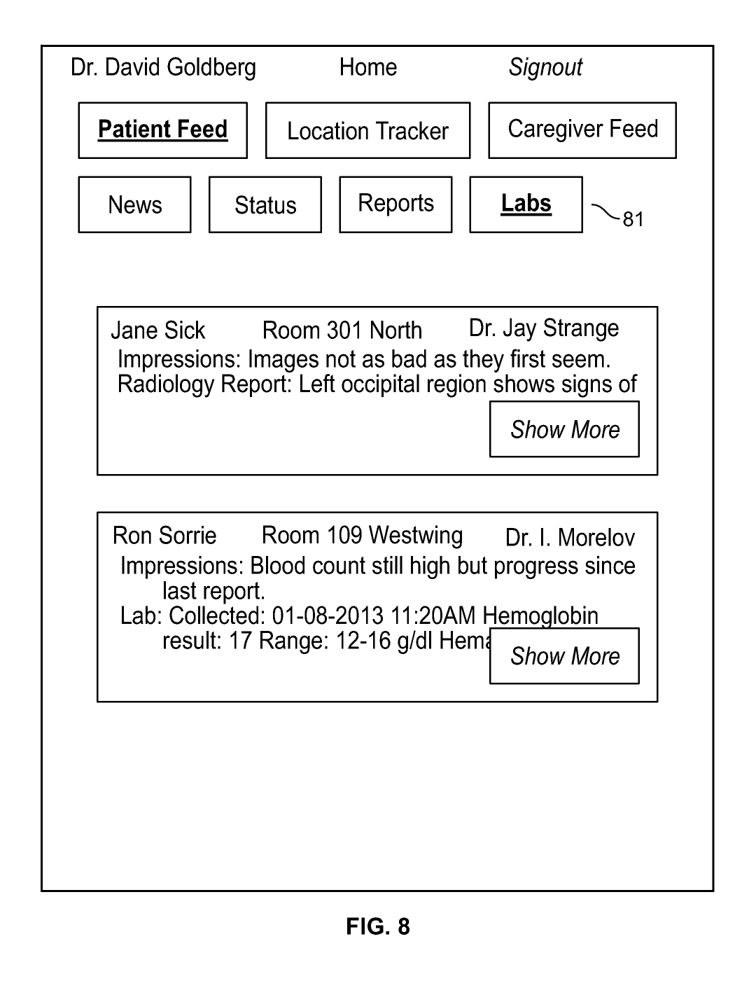

FIG. 5A illustrates how a member can log on to receive patient feed information and otherwise to participate in the social network provided by the social network platform. FIG. 5B illustrates the patient feed provided to the member. Using search button 51 illustrated in FIG. 5B, the member is able to search for patient information. Further, the member is able to review additional information for each patient by pressing show more or more button 52 displayed for each patient in the feed. Also shown in FIG. 5B is filter button 53, which when pressed causes display of a number of filter options. Such filter buttons 81 are shown in FIG. 8. The filters allow a member to filter patient information received according to various criteria so as to limit patient information that is provided to the member. Filters will be described in greater detail below. Patient information is provided in summary fashion for each patient in the display illustrated in FIG. 5C, and FIG. 5D illustrates that the member is able to search patient information by patient name by other patient key criteria, such as date of birth and by physician associated with the patient, such as an attending physician and admitting physician, a follower physician, or the like. FIG. 5E illustrates that members are able to update information for the patient. Other functionality of the social network platform can be accessed by a member, as shown in FIG. 5F, and the member can access his viewable schedule, as illustrated in FIG. 5G.

That is, members who can view patient information connected to the primary member may include all of the members of the group, or may include only the contacting members, the overseeing members, the requested members, the requested members or the transactional members, or a combination of the foregoing types of members. The group can include all of the caregivers of professional practice, hospital, clinic or other medical center, or a unit or division or a ward or a wing or practice of the foregoing type of organization, or may be an ad hoc group formed within the foregoing. In addition, a user may be able to select as a patient data filter, a past patient or a current patient filter. The current patient filter allows a the member to view only information regarding patients for whom the member is assigned overseeing responsibility, for example, as an attending physician, an ordering or prescribing physician, as a resident or the like, or as a combination of the foregoing. By selecting the past patient filter, the member can view patients for whom he or she has previously had such responsibility but does not currently have such responsibility. For example, a member may be a physician who is “covering” for another physician for the weekend or some other period of time during the second physician's absence from the medical facility. When the first member finishes his duties covering for the second physician's patients, information for such patients can be filtered to the first member such that information regarding patients for whom the first physician previously had responsibility during that weekend are no longer automatically pushed to be displayed to him. However, the first member can select the past patient's filter so that such information for patients for whom he provided care during that weekend are displayed to him in addition to the first member's current patients, or such that only information regarding such past patients is displayed to him. FIG. 8 illustrates some examples of filters that may be selected by the member.

Also contemplated is a location filter, to allow a member, such as an administrator, for example, a care coordinator for a wing or a floor of a hospital, to follow automatically all patients in the member's wing or floor. Thus, the patient data provided to that member would be restricted to patients in that location, such as in that wing, floor or unit. In addition, such a care-coordinator or other such member may be interested in how soon beds in that location are likely to become available for new patients. Accordingly, information about patients in that location may be ranked, and then provided to that member such that patients for whom fewer remaining procedures remain or information for patients in a less acute condition, are displayed first or displayed more prominently to that member. Thus, patients may be displayed in a reverse priority ranking, such that patients with a lower priority ranking are displayed more prominently. A patient with a less acute condition is more likely to be discharged first, making the patient's bed available earlier to the next patient than that of other patients.

Thus, node relationship analyzer 24 will determine whether the user is a member who falls into one of the foregoing categories and will provide access to patient information accordingly, or, depending on the application, will actively (push) or transmit contact to the user in order to inform the user about the status or diagnosis or medical condition, or the like, for the patient.

However, not all information will be transmitted to all users. Triage controller 25 may be used to screen the pieces of information that are actually transmitted to the members. Although illustrated as distinct modules, the structures illustrated in FIG. 1 may be combined or portions of various modules can be provided separately or combined in ways other than as illustrated.

Table 1 illustrates a triage ranking algorithm, provided as an example of a triage system according to an aspect of the present disclosure.

TABLE 1
Triage Ranking

| Factor | Weight |
|---|---|
| Time since admission (in days) | 25% |
| Readmission within 30 days (Y/N) | 5% |
| Number of exams in 48 hrs (0-10) | 20% |
| Patient relationship (Y/N) | 10% |
| Number of medications | 5% |
| Age | 10% |
| Patient Queries (how often users look up | 10% |
| patient in last 48 hrs)(0-10) | |
| Documented Problems | 5% |
| Patient locations (Y/N) | 10% |
| Total | 100% |

The number of documented problems can mean an ICD9 or SNOMED number that is discretely entered as an item in the problem list for a patient. For example, if a patient was admitted to a hospital and the physician entered in SHF, diabetes, HTN, Lupus, and A-fib, as five discretely entered items in the problem list then a factor of five would appear as the number of documented problems.

It will be understood that other weighting criteria may be assigned in addition to, or instead of, each of these criteria and that fewer or more criteria may be used. Also, the weighting factors herein noted are provided only as illustrative examples to produce the triage ranking. For example, weighting criteria that may be used instead of or in addition to the foregoing weighting criteria may include demographic information, such as MRN, FIN/encounter number (visit number, which may be the visit number for the site where the patient is located), date of birth, age, visit reason, location, primary care physician, consulting physician, responsible physician, height, weight; status information such as gender; patient tracking information such as patient status admitted, patient status discharged; medical history information, such as allergies, adverse reactions; charting information, such as problem/SNOMED, problem/ICD9/ICD10, vital signs, medications, either taken in the past, taken currently or prescribed, physician ED notes, TEE; results review, such as lab results, radiology results, cardiology results; social information, social history, including smoking, drinking, drugs use; patient history, including such criteria such as past medical history, family history, results, Op reports, pathology reports, consult reports, discharge summary, history and physical, echocardio report, Cath report, vascular lab report, perhifieral vascular procedure and the like. The foregoing weighting criteria can be used alone or in combination, or a selected group of the foregoing criteria may be used in addition to or instead of the criteria mentioned above.

TABLE 2
Example of Patient Data Ranking

| | Triage | | | Maximum |
|---|---|---|---|---|
| | (input values) | Triage Ranking | Weight | Value |
| Patient Admission Date | Aug. 10, 2012 | 0.0% | 25% | |
| Readmission within 30 days (Y/N) | No | 0.0% | 5% | 1 |
| Number of exams in 48 hrs (0-10) | 0 | 0.0% | 20% | 10 |
| Patient relationship (Y/N) | Yes | 10.0% | 10% | 1 |
| Number of medications | 7 | 2.0% | 5% | |
| Age | 85 | 8.5% | 10% | |
| Patient Queries | 0 | 0.0% | 10% | 10 |
| (how often users look up patient in | | | | |
| last 48 hrs) (0-10) | | | | |
| Documented Problems | 5 | 1.0% | 5% | |
| Patient locations (Y/N) | Floor | 0.0% | 10% | |
| | | 21.5% | 100% | |
| Cases to Run | | | | |

| | |
|---|---|
| 55 yo with diverticulitis on 5 meds, my patient, 4 MP, 7 tests, admitted today, | 58.5 |
| floor-(assume 2 patient queries) | |
| 78 yo with STEMI, 13 MP, on 13 meds, my pt, 6 tests, admit 3 days ago, | 44.8 |
| step-down-you didn't say queries (assume 2) | |
| 24 yo with appy admitted yesterday, 7 tests, my patient, 2 meds, 1MP, floor- | 40.4 |
| (assume 2 patient queries) | |
| 85 yo PNA, readmitted today, DC'd 2 wks ago, 18 meds, 12 MP, 4 tests, 2 | 75.5 |
| queries, ICU | |
| 78 yo admitted 6 days ago for surg, no tests, my pt, 7 meds, no queries, | 21.5 |
| 5 MP, floor | |

The system may use a cutoff point or threshold value below which patient information for the patient will not be pushed to the primary member or will not be pushed to other members. For example, the number may be 50 or 70 or 35 or the like. In addition, the system may provide a filtering tool to the members so that members can set their own number, for example by signing a score of 1-100 to allow members to filter patient and data received based on the numeric score assigned to each patient. Below the threshold score the patient information will not be advanced to the member.

In the alternative, the system may use a numeric cutoff limiting the number of patients for whom patient information is pushed to the member or made available to the member, for example 3 or 5 or 10 or 20 or the like. Or, the filtering tool available to members may allow the member to select the maximum number of patients for whom patient information is automatically pushed. Under this scenario, patients would “compete” for a top position based on the maximum value assigned by the ranking system such that for any given member, only patient data for patients with the highest maximum values would be pushed to the member. For example, if the member uses the filtering tool to designate 5 as a maximum number of patients that would automatically be pushed, then the system would select the five highest scoring patients based on the maximum value they obtained in the ranking, and only patient information for those five would be pushed to the member. In addition, based on the ranking for the five patients, information for one or more of the patients with a higher obtained ranking or higher triage results, could be displayed more prominently or higher on the list than the information for remaining patients. FIG. 8 shows that for Dr. Goldberg's feed, patient named Jane Sick is shown more prominently, in this case higher on the page, than other patients.

According to one aspect of the disclosure, the primary member, for example a member who is in charge of the patient or is the attending physician for the patient or the like, could receive patient information for an unlimited number of patients, or could use the filtering tool to limit the number of patients for whom patient information is received in the same way as other members, or the system could automatically set the limits as for other members.

Such patient information may be pushed actively by the system to the user or the system may merely allow access to the patient information for the user based on the triage ranking results. Based on the weighting of the factors listed in the Triage Ranking Table 1, pieces of information about the patient are ranked and can then be transmitted to the other members of the organization, the group within the organization, or the sub-group as above-described.

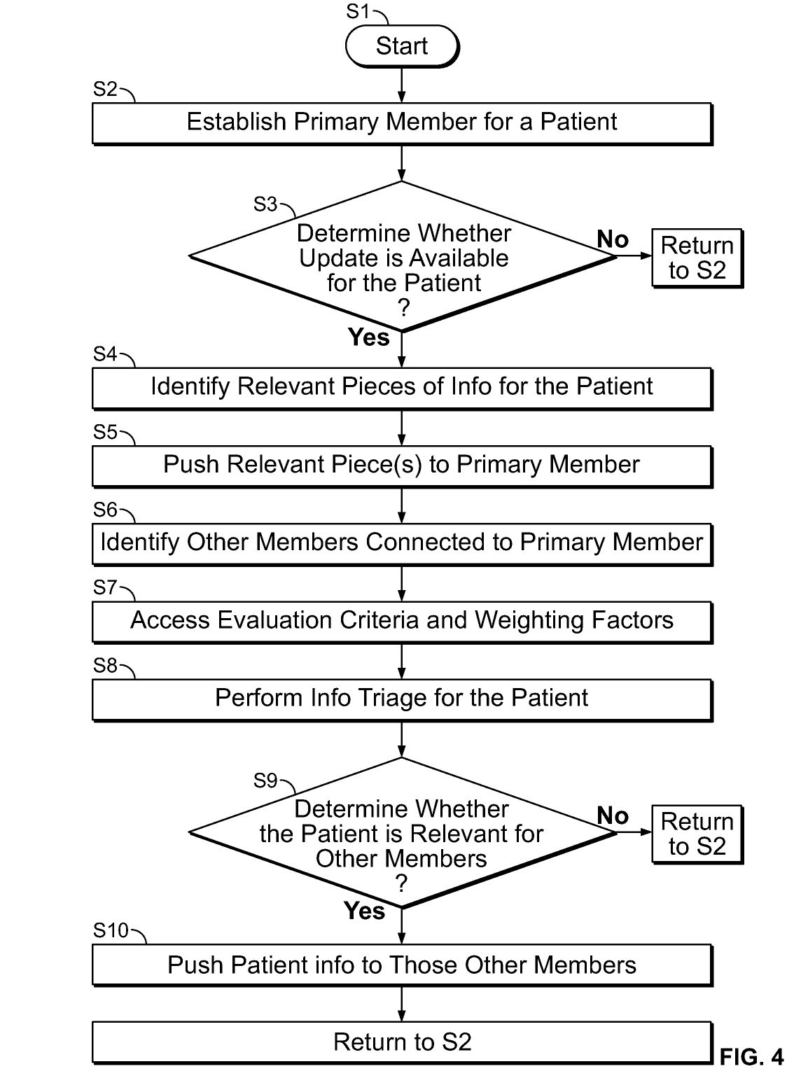

FIG. 4 is a flowchart illustrating process steps for making information available to a primary member and other members connected to the primary member for patient information.

After system start, at S2, a primary member for the patient is established. This may be performed by the primary member or a designee of the primary member, manually inputting key information for the patient, or may be performed by the system automatically based on certain criteria described below. The primary member, for example, may be the attending physician of the hospital, clinic, or other kind of medical center, may be a primary care provider or family physician, may be the chief physician for a unit or ward, or the like, of a hospital, or other medical organization, may be the admitting physician, or the physician with chief responsibility for the patient, or may be a physician or other caregiver who has been assigned as a primary member for the patient in the system, irrespective of the relationship of other more senior physicians or caregivers and the hospital hierarchy. Criteria for automatically establishing a member as a primary member for a patient may include such factors as whether the primary member is the attending physician, the chief physician of a hospital, medical unit of a hospital or ward, the primary member was the admitting physician for the patient or the physician who most extensively cared for or treated or oversaw treatment for the patient, is the named billing physician for the patient or is the named physician for insurance billing purposes, is the referring physician and other such factors.

At step 3, the system determines automatically whether an update is available for the patient. Such an update may include any type of new patient information or medical information, or patient envelope information, as above-described. If patient information update is available for the patient, then at S4, the relevant piece of information for the patient is identified for the primary member and at S5, this relevant piece of information is pushed to the primary member. That is, when checking his or her page in the networking platform, the primary member will be able to view automatically the relevant piece of information updated for the patient. However, it will be understood that while described as a push operation, that is, the system automatically transmitting the relevant piece of information for viewing by the member, the system may merely notify the member of the existence of an update, or provide a highlighted or summarized version of the piece of information, or the system may merely make available for viewing or access by the member without actually transmitting the information or summary or indication of the existence of information to a member. Also, the primary member or other members may wish to update their status concerning a patient on their own, without accessing the patient information feed, or may provide a comment on the piece of information provided by the patient data feed. For example, a member may wish to describe, as opposed to his page, information concerning the patient, for example, describing symptoms of the patient that the member gleamed on a recent visit or describe medical diagnostic testing results, medical imaging results, vital sign statistics, medications taken or prescribed or considered, or other types of medical information or patient envelope information as discussed above. Such pieces of information could also be then identified as a starting point for triage analysis, that is, the system can then determine whether other members should be notified of this caregiver-provided information in steps S6-S9.

In step 6, other members connected to the primary member are identified. As discussed, such other members may be all the members of a unit of a hospital or medical organization, members of an informal network of the primary member, or a unit, ward, wing or professional practice group within the hospital or medical organization, or may be one or more of the following: contacting members, overseeing members, requested members, transactional members, or following member, as above-described.

At step S7, the system will access evaluation criteria and weighting factors, as described in Table 1. At step S8, triage information is performed for the patient based on the evaluation criteria and the weighting factors obtained at S7. Based on the triage results, at S9, the system determines whether information about this patient is relevant for other members, and if so, information is pushed to those other members. As discussed above, while described as “push” operation, the system may make it available the information to the other members in other ways.

Information for a patient with a higher triage result, such as a higher ranking based on the weighting of the evaluation criteria, can be displayed more prominently or ahead or information for other patients provided to the displays of the members. Thus, when any given member of the network accesses the network, information for such patients with higher ranked results or higher triage results can be displayed first or ahead of the information of the remaining patients, or can be displayed more prominently than remaining patients. For example, such patients can have their information presented in a different color, in larger letters, in a different font, in a different italicization or underlining or the like. In addition, audio information may be provided when information for such patients is pushed to the display of a member.

For any given patient, some patient data may be provided more prominently than the remaining patient data. For example, impressions, findings, conclusions, notes or other such analysis of a physician or a caregiver or a professional based on a review, evaluation and assessment of a medical or patient data, may be provided before the remaining patient data for the patient. For example, for any given patient such an impression or conclusion or findings field may be provided in a different color or may be provided first in order, or higher on a display page, or using a different font, different italicization, different underlining, different letter or symbol characteristics, and the remaining data. FIG. 8 shows that for Dr. Goldberg's feed, for the patient named Jane Sick, the Impressions field is shown more prominently, in this higher in the patient information box, than other health information for this patient. FIG. 8 shows that Dr. Goldberg has selected the “Patient Feed” tab to receive patient information in the patient feed, and has selected the “Labs” filter tab to receive information only for patients for whom lab results have been received, or have been received within a time period of previously specified length, such as a day, an hour, a week, or the like.

The system then returns to S2.

S5 illustrates an exemplary page of a member when viewing the networking platform, according to an aspect of the present disclosure. While illustrated as a straightforward networking page with a little image next to the person's name, and comments by other members adjacent to the member and showing the date and time of the posting of the comment, it will be understood that many other types of such configuration are contemplated. Patient data may also be filtered according to one or more filters selected by a member. For example, a filter may be a news filter, providing patient information that is received within a past previously defined period of time, such as an hour or ten minutes or a day or the like; a status filter, which shows patients for whom status information has been received, such as patient is out of surgery and is doing well entered by a doctor or other caregiver for a patient; a laboratory filter, showing information for patients for laboratory information, such as a microbiology report, a CT, X-ray or other radiology or other patient imaging report, or other type of laboratory report or analysis has been received; and a report filter showing patient information for patients for whom other kinds of reports have been received.

An auto-follow feature may also be provided, according to which doctors or other caregivers who have prescribed medication, ordered a test or a laboratory or patient imaging or surgery or a prescription or otherwise directly participated in the care of a patient, or the like are automatically selected as followers of a patient. Such followers of a patient automatically receive all patient data for that patient as relevant for them. Members may also be allowed to provide a follow instruction for a patient, which when received will cause the server to provide information for the patient to that member.

Also contemplated is a specialist weighting feature, according to which the specialty or professional field of various doctors or caregivers or other professionals are stored by the platform and patient information is ranked and weighted according to how relevant the target patient information is to the professional field of expertise. Thus, patient images relating to x-rays of a lung would be of particular relevance to an oncologist or an oncology surgeon, but may be less relevant to podiatrists. Accordingly, each medical condition associated with a patient, such as a medical diagnosis, or a primary diagnosis for which the patient is currently admitted or is being treated, or which is the primary ailment of the patient, or each type of data for a patient, such as, lung x-ray, would be assigned a ranking for each type of specialist. For example, a lung x-ray report would be of particular relevance to an oncologist and might be given a high weighting for an oncologist and a low weight for a podiatrist. Accordingly, the information for the patient would be ranked according to such weighting factors for each member according to the professional field of the member, and the patient given an overall ranking based on such results for each member. The patient information would be transmitted to each member, by specialty, according to the overall ranking of the patient given the professional field of the member.

Some members may be automatically added as followers of a patient. For example, an admitting physician, that is, the clinician who admits the patient to a hospital, clinic or other medical facility, or a unit thereof, an ordering physician, that is, a clinician who orders a medical test, examination, a laboratory analysis, medical imaging, or prescribes a medication, or the like for a patient, a covering physician, that is, a clinician who assists with patient care because another physician is not currently available or is away for a period of time, and an attending physician, that is, a clinician who has overall responsibility for care of the patient during the patient's stay or visit to a hospital facility, can automatically be added as followers of the patient who will automatically receive information for the patient as part of their feeds.
According to an aspect of the disclosure, a ranking factor can also be assigned to the patient based on the relationship of the physician to the patient. For example, an ordering physician or an attending physician can be ranked as having a higher-order relationship to the patient than an admitting physician. For example, by default, an attending physician may be given a relationship ranking factor of 5, while an admitting physician may be a given a ranking factor of 2, such that the same patient can be displayed more prominently to the attending physician than to the admitting physician. In addition, users may be able to change the relative value of each physician relationship type to change the ranking of each clinician relationship type to the patient. It will be understood that system administrators at hospitals and other medical facilities can vary the types of clinician relationships that are possible and are relevant for the patients, and can also change the relationship ranking for any given physician type.

According to a location follow feature, a particular location, such as a bed, a floor, a unit or suite in an institution, such as a hospital, clinic or other medical facility, may be followed, and information regarding the patient currently assigned to that location may be tracked.

For example, an administrator of a hospital such as a care coordinator of a unit or a floor may need to know what else needs to be done before a patient in that unit, such as in that bed is discharged and a new patient can be admitted into that bed. For example, the care coordinator may know that a particular department is ready to admit the new patient but the current patient must first be discharged by a physician and the janitorial staff must finish cleaning the location before the new patient can be admitted. Thus, in the location tracking mode, an update would be provided to the member regarding the status of the given location, and information regarding the patient in the location may also be provided.

Each location can then be ranked according to how soon the location is likely to be available to the next patient. For example, a bed in which a patient needs only a final signature of a physician for a discharge can be ranked higher than a bed in which a second patient for whom lab results must be first received before he can be discharged. Thus, for the second bed, the lab results first have to come in, the responsible doctor has to review the results, and then the doctor can sign the discharge papers, if appropriate. Accordingly, the first bed would be ranked higher because fewer steps are required before discharge of the patient, and may be displayed more prominently such as before the second location or displayed more above other locations. Both the first and second bed, may be displayed more prominently than the remaining locations, which are likely to entail more time before they are made available for the next patient.

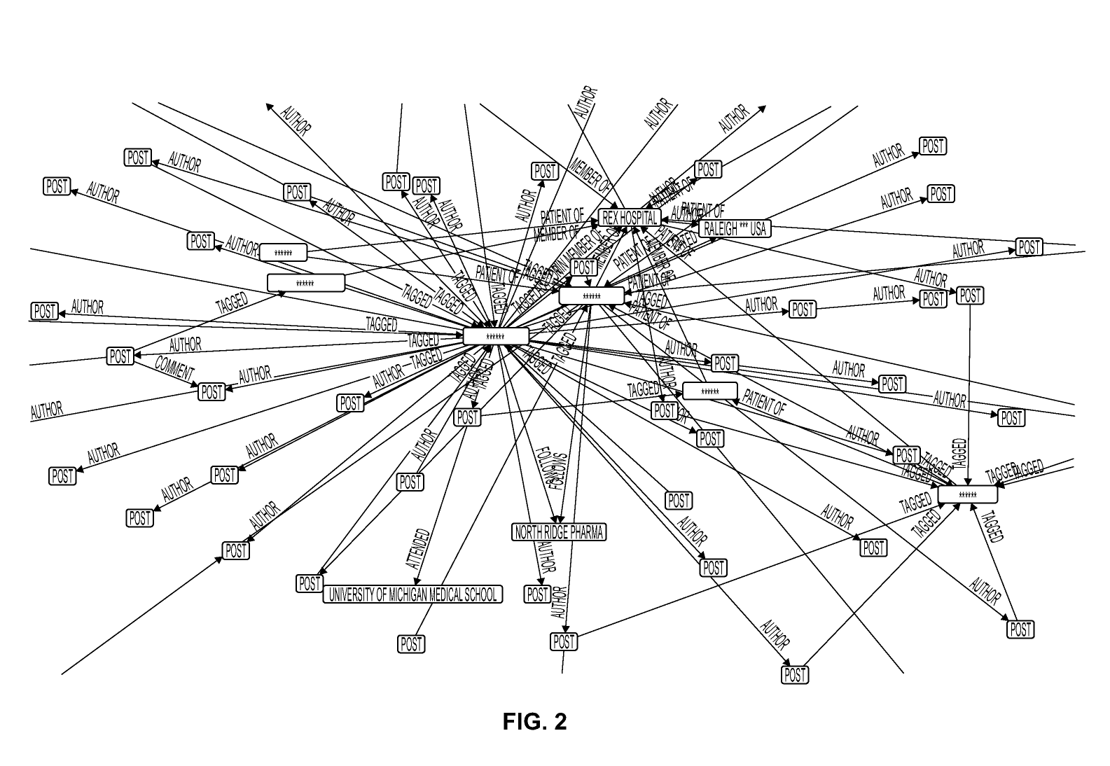

FIG. 2 illustrates a data modeling technique using graph database architecture, according to which information is stored in nodes. FIG. 2 illustrates such a graph database architecture. The database and the networking platform server can be provided in a private cloud so as to provide greater security.

Accordingly, stored data may be easily accepted, expanded and stored from a wide range of systems and sources without complex hierarchy management, that is without multiple tables involving rows and columns that is common to more traditional relational database management systems. Traversing nodes of a graph database architecture and returning to the data based on the node attributes is more effective and takes advantage of the principal of “guided serendipity,” according to which users are presented with data elements in the application based on their position to other nodes. Users can then make discoveries based on multi-factorial relationships. Accordingly, a data structure can be designed in accordance with how a clinician, such as a physician, need to communicate, and the clinician's relationship to the data. For example, a specialist in reviewing a recent update can have a hyperlink to his or her group, and this link will link to a list of all physicians that belong to the clinician's group. From this list of members of the group, the physician can view all the patients belonging or being followed by the other physicians of the group. Thus, guided serendipity can facilitate displaying relevant data for the users as they interact in the networking system. An NOSQL graph database architecture, for example, the Neo4J system offers scalability and performance, however, it will be understood that other types of data modeling techniques can also be used. The NOSQL graph database architecture may be object-oriented, and flexible to support multiple relationships and connections between nodes. PHP may be used a programming language tool and pages may be rendered using HTML, including HTML5, however, it will be understood that other types of program languages and data rendering systems may also be used in addition to or instead of PHP and HTML. Mobile client applications can be provided on iOS and android devices, as well as other types of phones and handheld and portable devices. An Apache web server may be used running on LINUX. However, it will be understood that other systems may also be used. HL-7 standards, such as 3.0 standards may be used and could support messaging for ADT, ORM, ORU, and CCD formatted messaging, however, it will be understood that other types of patient data may also be accommodated and processed.

FIGS. 5A-5H show example screens of a smartphone interface permitting a user to interact with the system.

In addition to providing patient data for members, the platform can also provide messaging functionality, in which members interact with each other by posting comments, status updates or news, pictures, text, articles or links to the foregoing so as to provide an effective professional networking platform. In addition, members can also send and receive private messages to one or more members, as well as to members outside of the group or sub-group as described above. An industry feed is also contemplated, which will allow members to connect with companies and vendors, such as pharmaceutical companies, medical device and medical imaging companies, third party diagnostic laboratories and medical imaging facilities and centers, or other types of companies and vendors of interest.

FIG. 3 illustrates that certain types of information may be provided for each member automatically, such as a photo of the member and the member's name. However, additional information may be provided, such as office location, an address information, office hours, availability, credentials, certificates, degrees and diplomas, healthcare specialty areas, institutional titles, answering service information, covering service information, location and access information, including on-call time, hours in surgery, location and/or mailing address or facility with which the member is affiliated or at which the member is located, data or time at which the user is scheduled to be available, education information and so forth. Such information can be input manually by the member or his designee, and may be restricted to only some members of the group or sub-group. Members can also provide status information, including what projects or what type of practice they are primarily interested in, the patients or a sub-group of patients whom they have treated, research projects on which they are working or for which they seek collaboration, contact information and back-up contact information. Such contact information or other types of information can be made to appear only when they are signed out of the system, that is as a clinical away message to other members.

Members can also elect not to receive any information regarding patients of other members or may restrict patient information from other members to their specialty or their group or sub-group, for example, to members who are part of their round in a hospital or clinic, part of their case review, or the like. A group administrator may also exist who allows users to participate within the group or sub-group. For example, the group administrator may be a caregiver or may be a hospital or clinic administrator or the like who acts as a gatekeeper.

The present methods, functions, systems, computer-readable medium product, or the like may be implemented using hardware, software, firmware or a combination of the foregoing, and may be implemented in one or more computer systems or other processing systems, such that no human operation may be necessary. That is, the methods and functions can be performed entirely automatically through machine operations, but need not be entirely performed by machines. Similarly, the systems and computer-readable media may be implemented entirely automatically through machine operations but need not be so. A computer system may include one or more processors in one or more units for performing the system according to the present disclosure and these computers or processors may be located in a cloud or may be provided in a local enterprise setting or off premises at a third party contractor. Similarly, the information stored may be stored in a cloud or may be stored locally or remotely. The computer system or systems for interacting with a user can include a GUI (Graphical User Interface), or may include graphics, text and other types of information, and may interface with the user via desktop, laptop computer or via other types of processors, including handheld devices, telephones, mobile telephones, smartphones or other types of electronic communication devices and systems. A computer system for implementing the foregoing methods, functions, systems and computer-readable storage medium may include a memory, preferably a random access memory, and may include a secondary memory. Thus, although illustrated as a system database 13, the information record system may be part of the same machine or may be located off site, and may be implemented as a floppy disk drive, magnetic tape drive, an optical disk drive, removable storage drive or any type of recording medium. Examples of a memory or a computer-readable storage medium product include a removable memory chip, such as an erasable programmable read-only memory (EPROM), a programmable read-only memory (PROM), removable storage unit or the like.

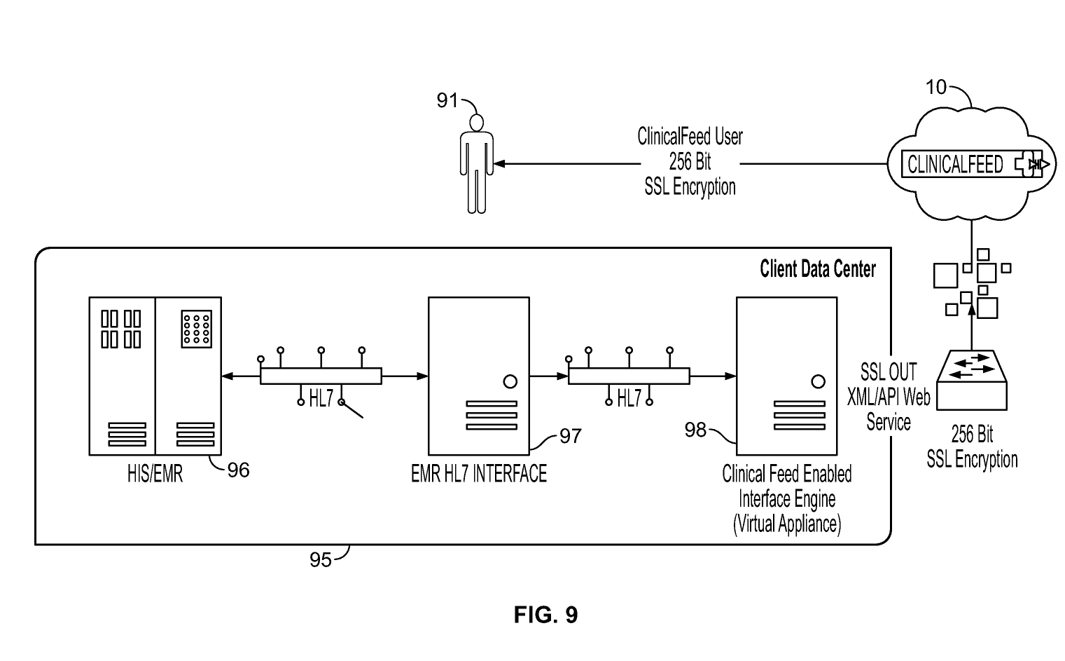

FIG. 9 illustrates a system for providing hospital information system (HIS) or electronic medical record information (EMR) about patients to the server 10 that provides the social network, and ultimately to the members who use a social network. In particular, FIG. 9 illustrates that HIS or EMR system, which may be located as part of client data center 95 in the institution or offsite, or may be provided in a cloud or private cloud or the like, communicates with EMRHL 7 interface 97. EMRHL 7 interface may be provided as software, hardware or a combination of the foregoing and provides a data stream pursuant to HL 7 interface protocol. Client data center may also include a clinical feed enabled interface engine or virtual appliance 98, which may be implemented as software, hardware or some combination of the foregoing, that responds to patient data requests from server 10 located in the cloud or in a private cloud, provides a patient data feed, and/or otherwise acts as an interface for social network server 10. It will be understood that while shown as being provided in the cloud or as part of a private cloud, social network server 10 may be provided on-site in a medical facility or off-site.

The communication interface may include a wired or wireless interface communicating over TCP/IP paradigm or other types of protocols, and may communicate via a wire, cable, fire optics, a telephone line, a cellular link, a radio frequency link, such as WI-FI or Bluetooth, a LAN, a WAN, VPN, the world wide web or other such communication channels and networks, or via a combination of the foregoing.

While the preferred embodiments of the invention have been illustrated and described, modifications and adaptations, and other combinations or arrangements of the structures and steps described come within the spirit and scope of the application and the claim scope.

What is claimed is:

1. A processor-readable non-transitory medium incorporating instructions configured to provide, when executed by a data processor, a social network platform that is accessible, over a computer network, by members of a social network, the instructions comprising:
an evaluation criterion storage module configured to store and to retrieve at least one evaluation criterion;
a patient data reception module comprising instructions configured to receive, from an electronic patient data source, patient data regarding a plurality of patients;
an information ranking engine comprising instructions configured to identify, in the patient data, first target patient information associated with a first patient, when the first target patient information corresponds to the at least one evaluation criterion, and to assign a first priority ranking, according to the at least one evaluation criterion, to the first patient of the plurality of patients;
a network member updater comprising instructions configured to provide, according to the assigned first priority ranking, information regarding the plurality of patients such that information regarding the first patient is displayed to the members of the social network more prominently than information regarding other patients of the plurality of patients.

2. The processor-readable non-transitory medium of claim 1, wherein the patient data source is a data feed from an electronic medical records system of a medical facility.

3. The processor-readable non-transitory medium of claim 1, wherein the information regarding the first patient is displayed at a position higher on a display of the members of the social network than information regarding the other patients of the plurality of patients.

4. The processor-readable non-transitory medium of claim 1, wherein the at least one evaluation criterion comprises at least two criteria, and the first priority ranking corresponds to an acuity of a health condition of the first patient.

5. The processor-readable non-transitory medium of claim 1, wherein the information ranking engine comprising instructions configured:
to identify in the patient data second target patient information corresponding to the at least one evaluation criterion; and
to assign a second priority ranking, according to the at least one evaluation criterion, to a second patient of the plurality of patients, when the target patient information is associated with the second patient,
wherein the network member updater provides information to the members of the social network such that, when the first priority ranking is higher than the second priority ranking, the information regarding the first patient is displayed more prominently than information regarding the second patient, and, when the second priority ranking is higher than the first priority ranking, the information regarding the second patient is displayed more prominently than the information regarding the first patient, and
wherein the information regarding the first and second patients is displayed more prominently than information regarding the other patients of the plurality of patients.

6. The processor-readable non-transitory medium of claim 6, wherein the information ranking engine comprising instructions configured:
to identify in the patient data second target patient information corresponding to the at least one evaluation criterion; and
to assign a second priority ranking, according to the at least one evaluation criterion, to a second patient of the plurality of patients, when the target patient information is associated with the second patient,
wherein the network member updater provides information to the members of the social network such that, when the first priority ranking is higher than the second priority ranking, the information regarding the first patient is displayed less prominently than information regarding the second patient, and, when the second priority ranking is higher than the first priority ranking, the information regarding the second patient is displayed less prominently than the information regarding the first patient.

7. The processor-readable non-transitory medium of claim 1, wherein the instructions further comprise social network database instructions,
wherein the members are represented as nodes, and the database uses a graph data model architecture for relating nodes to each other.

8. The processor-readable non-transitory medium of claim 1, wherein the information ranking engine is configured identify, in the first patient target information, a first numeric value associated with the at least one evaluation criterion, and
to assign the priority ranking by first assigning a first weight to the first numeric value.

9. The processor-readable non-transitory medium of claim 8, wherein the at least one information criterion comprises a first evaluation criterion and a second evaluation criterion different from the first evaluation criterion, and
the information ranking engine is configured to identify, in a second patient target information associated with the first patient, a second numeric value associated with the second evaluation criterion,
to assign a second weight to the second numeric value, and
to assign the priority ranking according to a sum of the first numeric value multiplied by the first weight and a second numeric value multiplied by the second weight.

10. The processor-readable non-transitory medium of claim 1, wherein the at least one evaluation criterion comprises at least one of a time since admission, a patient age, a number of prescribed medications, a number of exams within a previously specified previous period, a number of diagnosed medical conditions, and a number of care giver queries of patient status within a previously specified previous period.

11. The processor-readable non-transitory medium of claim 1, further comprising:
a professional field storage module configured to store and to retrieve a professional field of members,
wherein the information updater provides the patient information regarding the plurality of patients only to a subset of the members of the social network whose professional field is relevant a medical status of the patient.

12. The processor-readable non-transitory medium of claim 1, wherein the patient data source is a data feed from a records system compliant with HL 7.

13. A method of providing a social network platform by a data processor, the platform being accessible, over a computer network, by members of a social network, the method comprising:
storing a first evaluation criterion and a second evaluation criterion different from the first evaluation criterion;
receiving automatically, from an electronic medical records system, patient data regarding a plurality of patients;
identifying automatically, in the patient data, by the data processor, first target patient information associated with a first patient and corresponding to the first evaluation criterion, including a first numeric value associated with the first evaluation criterion, and assigning a first weight to the first numeric value, for a first patient of the plurality of patients;
identifying automatically, in the patient data, second target patient information associated with a second patient and corresponding to the second evaluation criterion, including a second numeric value associated with the second evaluation criterion, and assigning a second weight to the second numeric value, for the first patient;
assigning automatically, by the data processor, a first priority ranking according to a sum of the first numeric value multiplied by the first weight and a second numeric value multiplied by the second weight; and
transmitting automatically, by the data processor, according to the assigned first priority ranking, information regarding the plurality of patients such that information regarding the first patient is displayed to the members of the social network more prominently than information regarding other patients of the plurality of patients.

14. The method of claim 23, wherein the first and second evaluation criteria each comprises at least one of a time since admission, a patient age, a number of prescribed medications, a number of exams within a previously specified previous period, a number of diagnosed medical conditions, and a number of care giver queries of patient status within a previously specified previous period.

15. The method of claim 23, wherein the method further comprises:
selecting automatically, as followers of the first patient, a subset of the members comprising fewer than all members,
wherein the followers comprise care givers who have at least one of ordered a test for the first patient, ordered a laboratory analysis for the first patient, ordered medical imaging for the first patient, and prescribed a medication for the first patient,
wherein the transmitting of the patient information for the first patient is performed only to the followers of the first patient.

16. The method of claim 25, wherein the method further comprises:
receiving a follow patient instruction from a first member; and
automatically adding the first member, as a follower of the first patient, responsive to the follow patient instruction received.
